(19) United States
(12) Patent Application Publication
(10) Pub. No.: US 2024/0270616 A1
(43) Pub. Date: Aug. 15, 2024

(54) REUSABLE BATH BOMB VESSEL

(71) Applicant: Andrew Dillow, New York, NY (US)

(72) Inventor: Andrew Dillow, New York, NY (US)

(21) Appl. No.: 18/582,552

(22) Filed: Feb. 20, 2024

Related U.S. Application Data
(63) Continuation-in-part of application No. 17/329,914, filed on May 25, 2021, now Pat. No. 11,905,190.
(60) Provisional application No. 63/072,949, filed on Sep. 1, 2020.

(51) Int. Cl. C02F 1/68; A47K 3/00; H04R 1/02

(52) U.S. Cl. CPC C02F 1/688; A47K 3/001; C02F 2201/005; C02F 2201/007; H04R 1/028

(57) ABSTRACT

A submersible vessel which can act as a reusable bath bomb delivery system is provided. The vessel may include a housing and an opening port. The interior of the housing and ports form a chamber, which can be segmented into multiple sub-chambers. Inlet one-way valve(s) and outlet one-way valve(s) are provided on the vessel. To use, the chamber is partially filled with a mixture including an effervescent material. When water is introduced through the inlet valve, it reacts with the effervescent material, releasing carbon dioxide and dissolving the other ingredients in the mixture, building pressure in the chamber. When the pressure builds to a certain level, the inlet valve(s) are closed, and the outlet valve(s) are opened. The outlet valves may be positioned such that when the fluid and gas is expelled, the force generated may cause the vessel to spin or be propelled in the bath.

### CROSS-REFERENCE TO RELATED APPLICATIONS

This application claims priority to U.S. patent application Ser. No. 17/329,914 filed on May 25, 2021 and entitled “Reusable Bath Bomb Vessel” and U.S. Provisional Patent Application No. 63,072,949 filed on Sep. 1, 2020 and entitled “Container Or Vessel That Holds Effervescent Salts And Can Be Placed In Water To Create a Reusable Bath Bomb”, the entire contents of which are incorporated herein.

### TECHNICAL FIELD

The present disclosure relates generally to a submersible vessel that, when filled with an effervescent material and submerged in water, allows the water into a chamber in the vessel and then allows the fizzing water out, and in particular to a reusable bath bomb.

### BACKGROUND

There are a number of products for creating an effervescent bathing experience, such as bath bombs or salts. Some solutions offer a single use product where the salts are molded into a shape and dropped directly into the water. However, once the bath bomb is dissolved, the shape is lost and so the only option is for the user to use another bath bomb the next time.

Other products attempt to allow a user reuse a solid, dissoluble bath product a number of times by allowing the bath product to partially dissolve and then removing it from the water until the next use. However, these products can be messy to store as there is no container for the effervescent product, so after it has been used once, it continues to dissolve even when not in the water and may leave a residue when stored.

Still other products provide easily storable effervescent products that can simply be poured into a bath, but are not formed into a shape, and do not provide the novelty and fun of having the product fizz from the shaped material or container.

FIG. 1 shows a traditional single use effervescent bath product being formed in a mold. These are commonly referred to as bath bombs. A mixture 100 of an effervescent material along with other desired ingredients, such as fragrance, e.g., essential oils and/or aroma compounds, binding ingredients, epsom salts, coloring agents, etc., are packed into a mold 102 and formed into a shape. FIG. 2 shows the molded bath bomb 200 being placed into a bath, where it will slowly dissolve and fizz, releasing the other ingredients, such as fragrance and epsom salts.

### SUMMARY

An object of this disclosure is to provide a device that makes an effervescent bath product, or bath bomb, which is reusable, rather than single-use, and which is easy to use and clean.

Another object of the disclosure is to provide a device that does not require excessive wasted packaging for each use.

Another object of the disclosure is to provide a device that can be created in various shapes, e.g., an animal or a cartoon or movie character, which can release a fizzing product and even travel or spin when dropped into water.

In an embodiment, a submersible vessel which can act as a reusable bath bomb delivery system is provided. The vessel may include a housing and at least one resealable opening port. The interior of the housing and ports form a chamber, which can be segmented into multiple sub-chambers.

At least one inlet one-way valve and at least one outlet one-way valve are provided on the vessel. The valves may be, for example, diaphragm check valves, however other types of valves may be used.

The chamber is partially filled with a mixture including an effervescent material. When water is introduced through the inlet valve, it reacts with the effervescent material, releasing carbon dioxide and dissolving the other ingredients in the mixture. This builds pressure in the chamber. When the pressure builds to a certain level, the inlet valve is closed. When the pressure builds to another level, the outlet valve is opened, releasing the reacted material and gas.

### BRIEF DESCRIPTION OF THE DRAWINGS

FIG. 1 is a perspective view of a traditional single use effervescent bath product being formed in a mold.

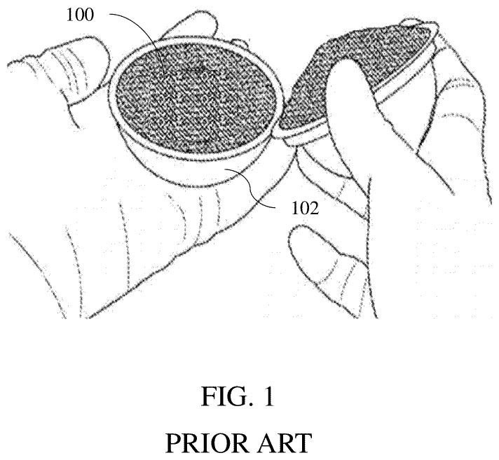

FIG. 2 shows the molded bath bomb being placed into a bath.

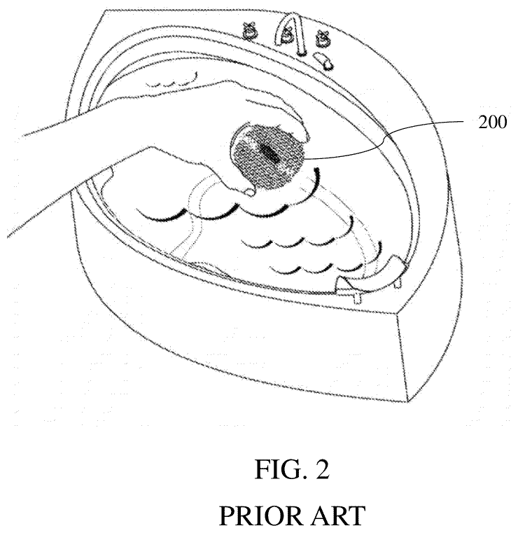

FIG. 3 is a perspective view of a basic housing for a reusable bath bomb vessel according to an embodiment.

FIG. 4 is a perspective view of a vessel including inlet and outlet valves.

FIG. 5 is an exploded sectional view of a one-way flow valve according to an embodiment.

FIGS. 6A and 6B are sectional views illustrating the operation of a one-way valve.

FIG. 7 shows a user partially filling the chamber of an exemplary vessel with a mixture including an effervescent material.

FIG. 8 is a perspective view of a vessel having a duck shape according to an embodiment.

FIG. 9 is a perspective view of a vessel with outlet valves positioned to create a rotating effect when fluid and gas is ejected from the valves.

FIG. 10 is a flowchart showing a bath bomb vessel operation according to an embodiment.

FIG. 11 is an elevation view of a modular bath bomb vessel according to an embodiment.

FIG. 12 is a perspective view of the modular bath bomb vessel of FIG. 11.

FIG. 13 is a perspective view of a modular bath bomb vessel according to another embodiment.

FIG. 14 is an exploded perspective view of the modular bath bomb vessel of FIG. 13.

FIG. 15 is a perspective view of a bath salt chamber according to an embodiment.

FIG. 16 is an elevation view of an interactive modular bath bomb vessel according to an embodiment.

FIG. 17 is a perspective view of the interactive modular bath bomb vessel of FIG. 16.

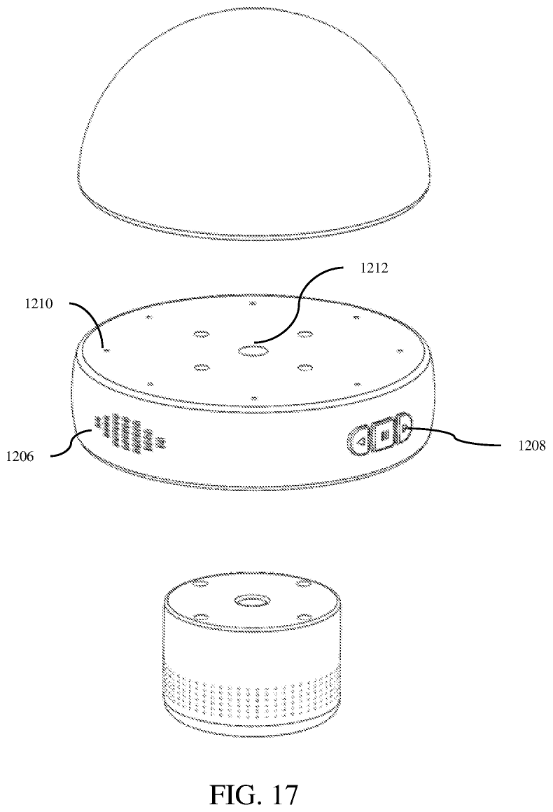

FIG. 18 is a perspective view of an interactive modular bath bomb vessel according to another embodiment.

FIG. 19 shows electrical and electronic components for a bath bomb vessel according to an embodiment.

### DETAILED DESCRIPTION

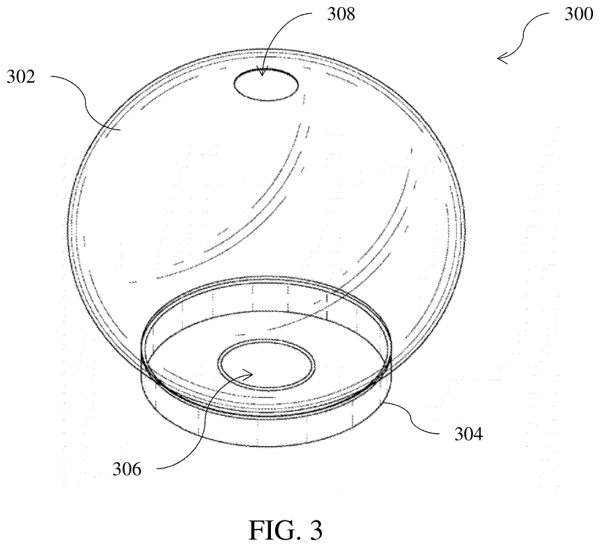

FIG. 3 shows a basic housing 300 for a for a reusable bath bomb vessel according to an embodiment. A main body 302, in this case having a roughly spherical shape, includes a removable lid 304 at a base, the interiors of which form a chamber. The lid 304 may be threaded to screw onto the main body or otherwise secured, and may have a protruding turreted edge to permit fluid to flow into the chamber if the vessel is, for example, submersed and lying on the bottom of a bath.

One or more inlet holes 306 may be provided in the lid 304 or other locations on the housing to enable water to enter the housing 300. One or more outflux holes 308 may be provided at the top or other locations on the housing to enable reacted product to fizz out of the housing 300.

In an embodiment, the material used for the construction of the body 302 and lid 304 may be a transparent plastic, although other materials may be used. In general, the material should be substantially rigid and waterproof.

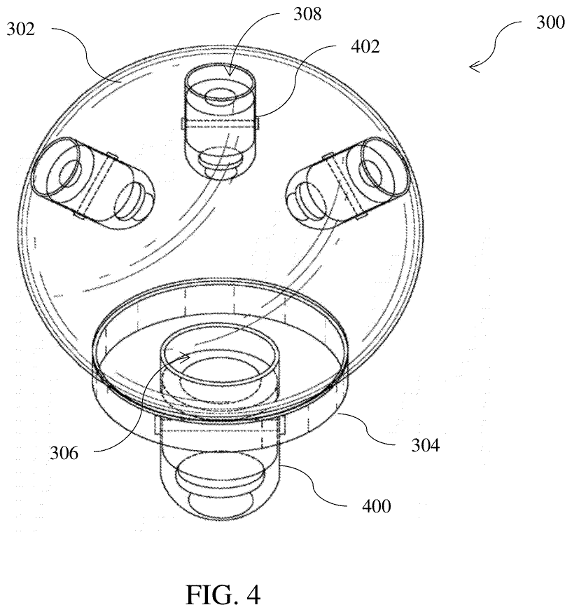

In an embodiment, an inlet one-way valve 400 configured to allow fluid into the chamber may be secured to the influx hole 306, as shown in FIG. 4. Outlet one-way valve(s) 402 configured to allow fluid and gas to exit the body 302 may be secured to the outflux hole(s) 306.

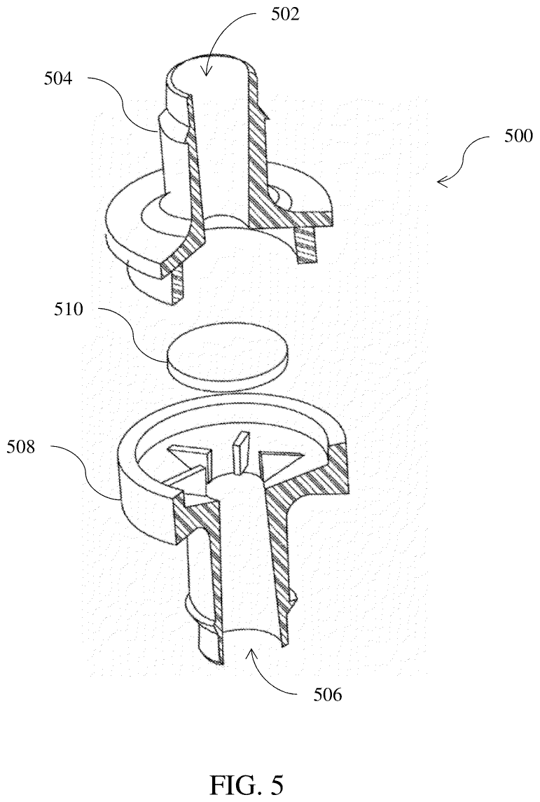

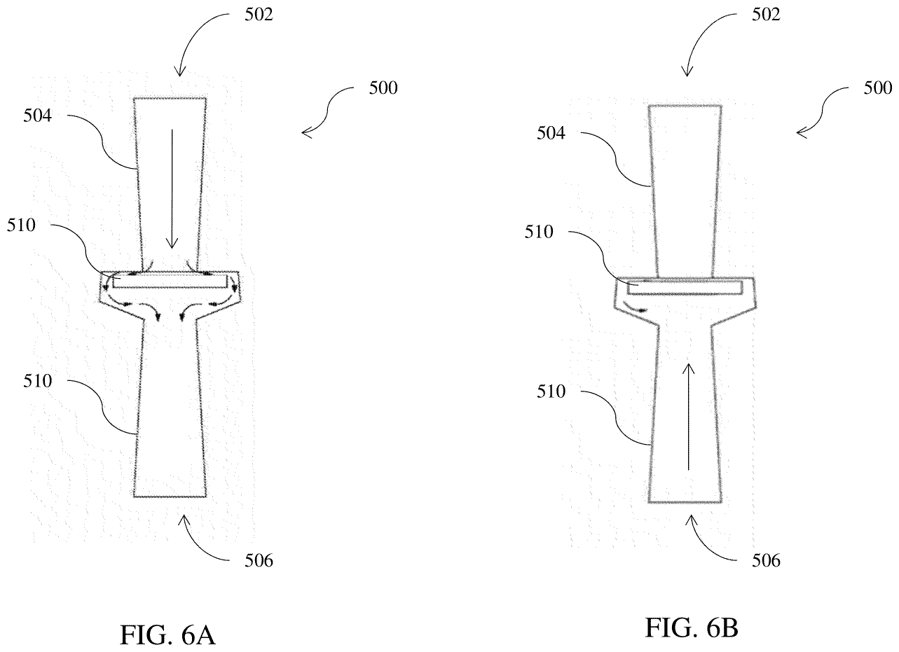

FIG. 5 shows an exploded sectional view of a one-way flow valve 500 according to an embodiment. The one-way flow valve 500 may be a diaphragm check, or non-return, valve. The valve 500 includes an inlet port 502 on an upstream section 504 and an outlet port 506 on a downstream section 508. The two sections 504, 508 are separated by a diaphragm 510. As shown in FIG. 6A, when fluid (represented by the lined arrows) flows through the inlet port 502 and creates a sufficient pressure differential between the upstream section 504 and the downstream section 508 to move the diaphragm 510, i.e., the valve's opening or cracking pressure, fluid flows into the downstream section 508 and out the outlet port 506. As shown in FIG. 6B, when the pressure of the fluid returning through the outlet port 506 increases to a point where the pressure differential between the fluid in the upstream and downstream sections fall below the valve's opening pressure, the valve closes, preventing further fluid through the valve 500. This may occur, for example, by pressure in the housing 300 increasing due to a reaction between the water and effervescent material in the housing.

Referring to the embodiment of the bath bomb receptacle shown in FIG. 4, the inlet valve 400 on the base (lid 304) may be configured to allow fluid into the housing 300, and the outlet valves 402 on the upper portion of the housing 300 may be configured to allow fluid and gas to escape the housing 300.

Other types of valves may be substituted for the diaphragm check valve for similar results, for example, ball check valves, reed valves, or a series of valves.

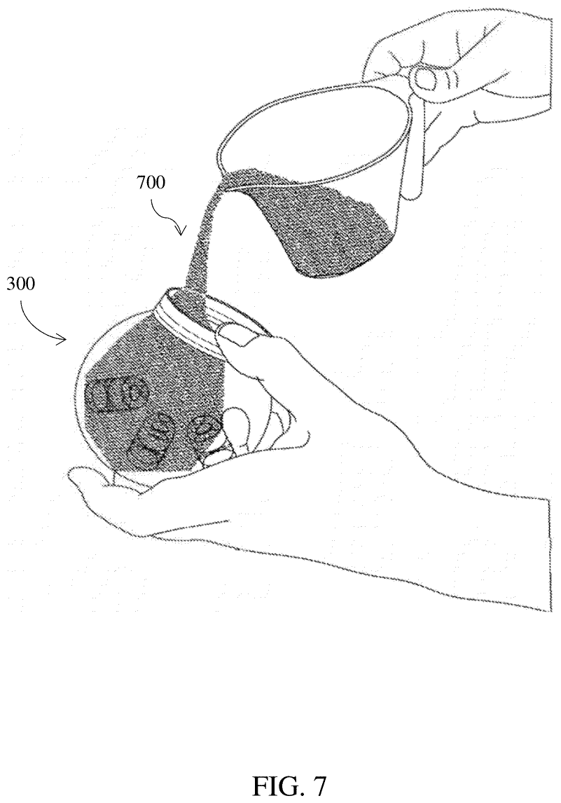

To use the reusable bath bomb vessel, the user may remove the lid 304 and pour a mixture 700 including an effervescent material into the body 302 of the housing 300, as shown in FIG. 7. The mixture may include, for example, an effervescent material along with other desired ingredients, such as a fragrance, e.g., essential oils and/or aroma compounds, epsom salts, coloring agent(s), etc. A commonly used and available effervescent material may include such ingredients as sodium bicarbonate and citric acid, but other ingredients are also contemplated, such as potassium, magnesium, and calcium carbonate salts and malic and tartaric acid.

The user may then re-secure the lid and place the housing into a bath or other body of water. Referring to the embodiment in FIG. 4, the user may need to partially submerge the housing 300 to provide enough pressure to exceed the opening pressure of the bottom inlet valve 400 and permit water into the chamber(s) including the mixture 700. As the water is allowed into the chamber to mix with the mixture 700, the reaction between the water and the effervescent material will start to produce pressure inside the chamber due to the release of carbon dioxide. At some point, the pressure differential between the upstream and downstream sections 504, 508 of the base inlet valve 400 may fall below the valve's opening pressure, and the valve will close.

When the pressure in the chamber exceeds the opening pressure of the outlet valves 402, the fizzing product will be released into the bath, creating a colorful, scented, fizzing experience.

The mixture 700 can, for example, be ordered and delivered as part of a monthly subscription service, or otherwise purchased. The user may then choose whatever combination of salts, fragrances, colors, etc., that they wish to create a unique and custom bath experience with their own color and scent combinations by filling the shaped receptacle with personalized mixture and dropping the vessel into the water (may be, but not limited to, a bath) to create the color and scent effect that they desire.

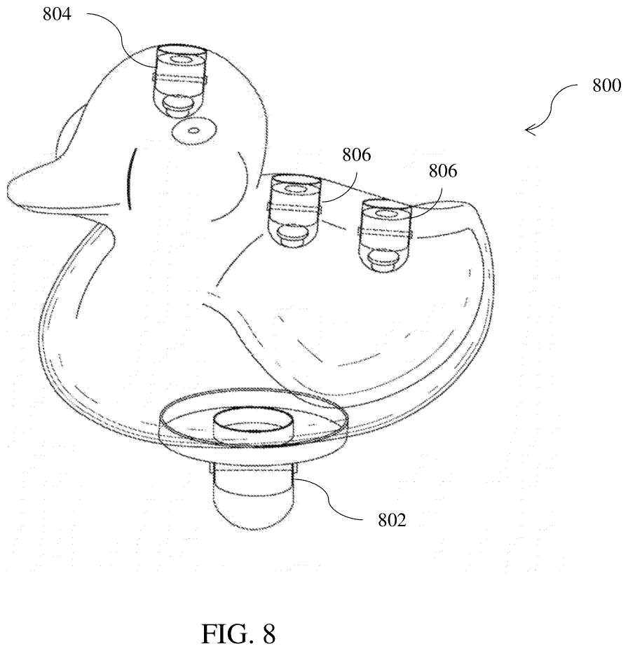

The housing may be created in a variety of shapes. For example, in the embodiment shown in FIG. 8, the vessel 800 has a duck shape to recreate the classic rubber duck bath toy. In this embodiment, water is allowed into the chamber through valve 802 and the fizzing product ejected from the valves at the head and body 804, 806.

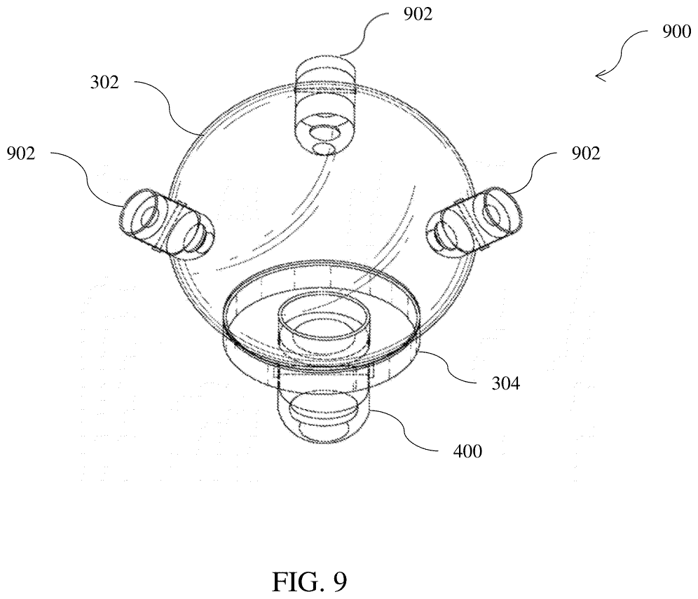

In an embodiment shown in FIG. 9, the outlet valves 902 may be positioned on the vessel 900 in the same direction, such that the force generated when the fizzing product is ejected from the valves will create sufficient momentum to cause the vessel to tend to spin the water. The outlet valves may also be provided on the same side of the vessel, tending to propel the vessel in the opposite direction.

The chamber may be segregated into sub-chambers, each including at least one input valve and one output valve and access by the user to place differently colored mixtures into the different sub-chambers. When the fizzing product is ejected from the different sub- chambers, different colors will be dispersed into the water, creating a rainbow effect.

In an embodiment the vessel chamber may be less than four litres to accommodate the size of a typical bath, although other sizes are contemplated.

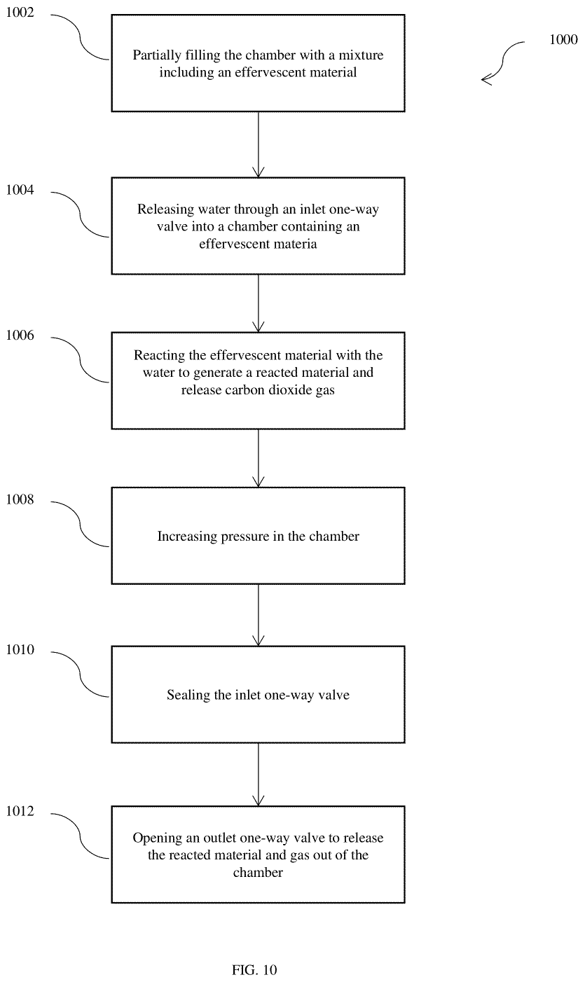

FIG. 10 is a flowchart showing a bath bomb vessel operation 1000 according to an embodiment. The chamber may be partially filled with a mixture including an effervescent material 1002. Water is then released into the chamber through an inlet one-way valve 1004. The water reacts with the effervescent material to generate a reacted material and release carbon dioxide gas 1006. This in turn increases pressure in the chamber 1008. When the pressure increases such that it reduces the differential pressure at the inlet valve below the opening press, the inlet valve is sealed 1010. When the pressure increases such that the opening pressure of the outlet one-way valve is overcome, then the reacted material and gas is released out of the vessel 1012.

The outlet valves may be positioned such that when the fluid and gas is expelled, the force generated may cause the vessel to spin or be propelled in the bath.

In an embodiment, the reusable bath bomb vessel may include a series of interchangeable modular components. The device may include core components including a bath salt chamber in which bath salts may be poured or compressed bath salt pellets or discs inserted, a number of apertures to enable water to enter the bath salt chamber, jet outlets to make the device spin when the reacted effervescent material is ejected, and interchangeable modular components that can be attached on the top of the bath salt chamber to create different experiences.

The modular components may include, for example, a blue tooth speaker, a globe containing a rotatable character, a “mushroom” top with a control panel, a volcano that can erupt reacted effervesent material, and an interactive device with buttons that allows the user to answer questions posed through the audio on the speaker.

The modular components may be connected and kept in place using magnets or other interconnecting components, such as clips. The modular components may include one or more holes through it's height to allow the effervescent reaction to flow from the bath salt chamber and into an enclosure (e.g., transparent globe or dome) out top of the bath bomb vessel and into the bath.

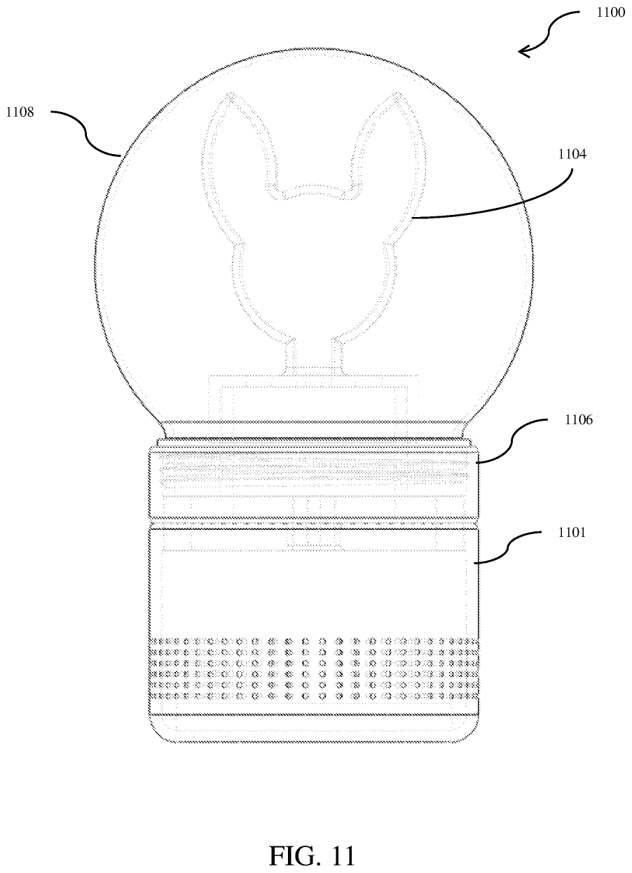

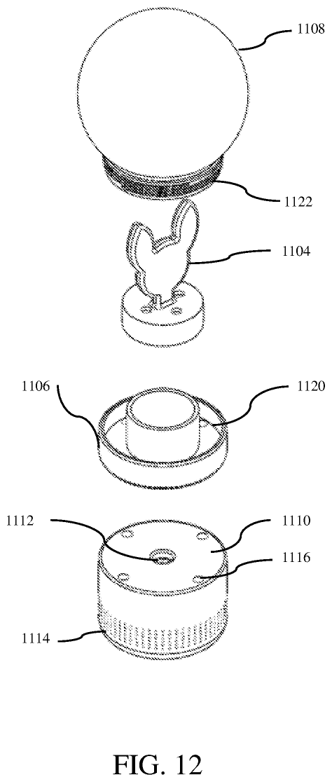

FIGS. 11 and 12 show a modular bath bomb vessel 1100 according to an embodiment. The vessel may include a bath salt chamber 1102, a rotatable character 1104, a base for the rotatable character, and an encasing globe 1108.

The bath salt chamber 1102 may include a removable lid 1110 to enable the user to pour a loose, granular bath salt product or place compressed bath salt pellet(s) or disc(s) into the body of the chamber. A central hole 1112 may be provided in the lid to allow the reacted effervescent material to move into the upper module(s), e.g., the globe 1108.

Holes 1114 may be provided on the sides and/or bottom of the chamber to allow the water into the chamber to react with the bath salt material. The number and size of the holes may be selected based on a number of factors including how rapidly water enters the chamber when submerged and how rapidly the reacted effervescent material can exit the holes, considering the rate of reaction and density of the reacted effervescent material in comparison to the bath water, internal and external pressures on the chamber during the reaction, etc.

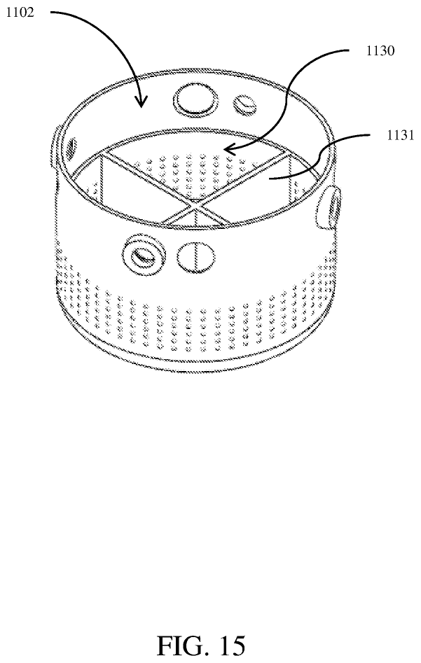

As shown in FIG. 12, the top of the lid 1110 may include magnet apertures 1116 into which magnets 1118 (FIG. 15) may be fixed or inserted. The character base 1106 may include corresponding magnet apertures 1120 into which the magnets may be inserted or fixed. As described above, other types of releasable connections between the modules are contemplated, such as clips.

The base 1106 of the globe 1108 may include threaded grooves which may be screwed into corresponding threaded grooves (not shown) on the inner sides of the character base 1106.

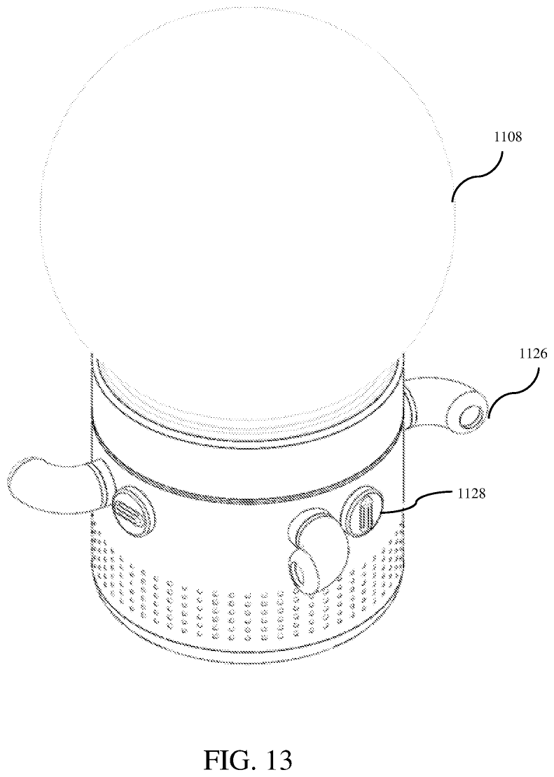

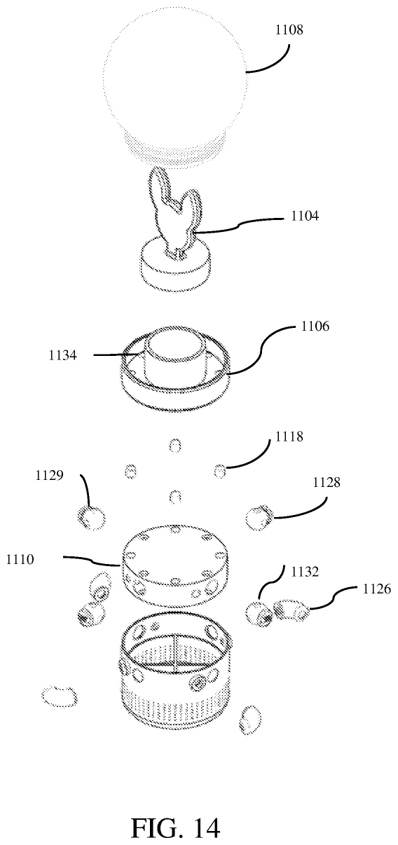

FIG. 13 shows another embodiment of the modular bath bomb vessel 1100 in which jets 1126 may be provided around the outer surface of the bath salt chamber. A manually adjustable (open/close) valve 1128 with through holes 1129 may be provided for each jet to control whether or not fluid Is ejected from that jet. The valves 1128 are shown in greater detail in FIG. 14.

The position of the jets may be adjustable, and when the valves 1128 are open, the direction of the jets will determine the direction in which the vessel spins. When the valves are closed, the reacted effervescent material may be forced into the globe 1108. The base 1106 for the rotatable character 1108 may also include one or more jets which may be angled such that a vortex is created in the globe chamber causing the character to spin.

Rather than a central hole 1112 for the transfer of reacted effervescent material from the bath salt chamber to the globe 1108, a number of holes 1132 on the edge of the lid 1110 with corresponding holes 1134 on the edge of the character base 1106.

In an embodiment shown in FIG. 15, the bath salt chamber may include sub-chambers 1130 separated by walls 1131. Different colored batch salts may be placed in each chamber prior to securing the lid to produce a multi-colored effect when the bath salts react with the bath water.

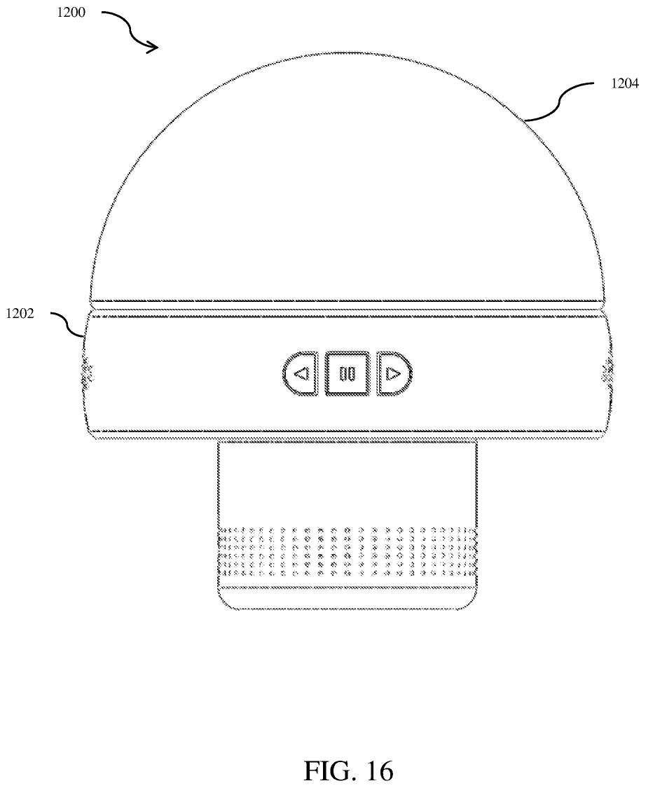

FIG. 16 shows a modular bath bomb vessel 1200 including a speaker module 1202. The speaker module 1202 may be sealed and water resistant in shallow depths to protect the electronic components. The speaker module 1202 may also include air chamber(s) for buoyancy and balance. A modular dome 1204 may be connected to the top of the speaker module 1202. The speaker module may also include speaker apertures 1206 covering internal speakers and control buttons 1208, e.g., play/pause, forward, reverse, etc.

The speaker module 1202 may include water-activated light sources 1210, e.g., light emitting diodes (LEDs) connected to water sensor/switches. When the sensors are bridged by water, an isolated electric switch turns on to activate the load, in this case the connected LED. In operation, when water and/or reacted effervescent material enters the dome portion through a central hole 1212 and contacts the water sensor/switches, the switches close and the water-activated light sources are turned on.

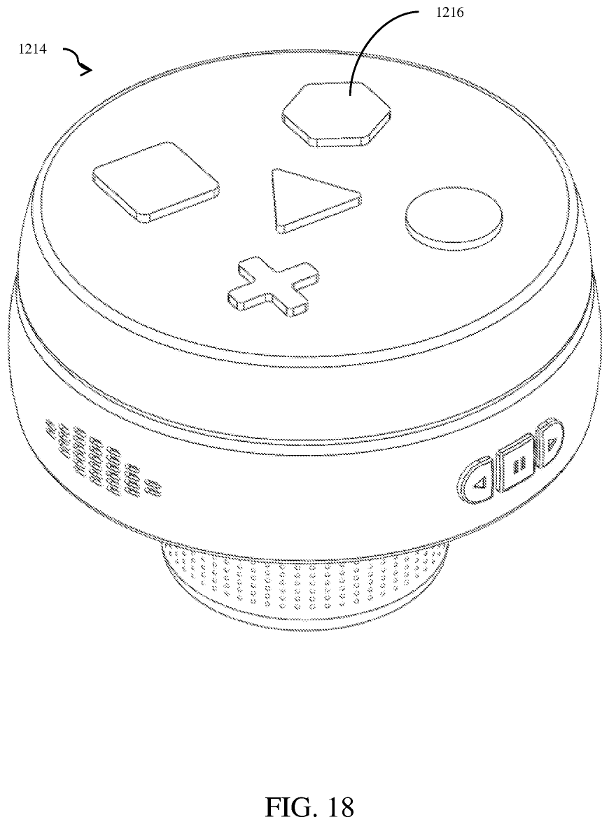

FIG. 18 shows an embodiment in which the dome is replaced by an interactive learning/entertainment module 1214. Interactive buttons 1216 may have different shapes and colors, or may be (semi-)transparent with one or more associated LEDs to provide different colors to the buttons. The speakers may play audio content from an internal memory or wirelessly streamed from a user device, e.g., a desktop computer, tablet, smartphone, virtual assistant (e.g., Siri, Alexa), etc. The audio content may be, for example, music, audiobooks/stories, interactive games, etc.

In an embodiment, the speaker module 1202 and interactive module 1214 may be used to play games specific to the device. For example, the user may be posed a question, for example, pressing a button of a certain shape or color, and if the user answers correctly, a sensor may control the release of the salts to make the effervescence and the spinning start or increase or decrease.

In another embodiment, the speaker module 1202 may be combined with the globe 1108 including the rotatable character 1104. The audio content, e.g., songs, stories, voices, etc., may be related to the character.

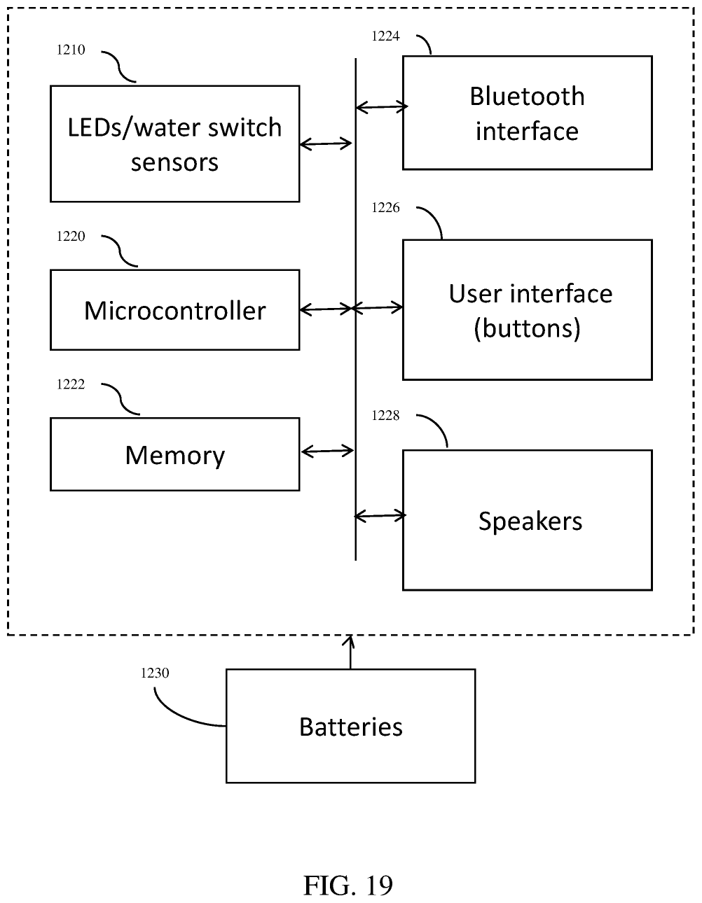

FIG. 19 shows electrical/electronic components of the speaker module 1202. Various operations may be controlled by a microcontroller/microprocessor 1220 with an associated memory 1222, which may include instructions for the operation of the microcotroller as well as preinstalled media content. A wireless interface 1224, e.g, Bluetooth, may communicate with the user device and/or virtual assistant 1226 via and integrated antenna and modem. The microcontroller 1220 may also control the sending and receiving of signals to water-resistant internal speakers 1228, interactive and control buttons, LEDs 1210, and a user interface. A battery or batteries 1230, e.g., rechargable or alkaline, may be provided to power the electrical and electronic components.

The foregoing method descriptions and figures are provided as illustrative examples only. The order of operations in the aspects described herein may be performed in any order. Words such as “thereafter,” “then,” “next,” etc. are used to guide the reader through the description of the methods and systems described herein, and do not limit the order of the operations. Further, any reference to claim elements in the singular, for example, using the articles “a,” “an,” or “the” is not to be construed as limiting the element Also, relative terms such as “top,” “bottom,” “upper,” “lower,” “above,” “below,” and the like as used herein describe the relative positions of elements or features, and are not limited to the orientations depicted in the drawings.

The components, blocks, modules, circuits, operations, etc. described may be implemented in hardware, software, firmware, or any combination thereof. Hardware implementation may include, for example, one or more application-specific integrated circuits (ASICs), field-programmable gate arrays (FPGAs), or other programmable logic devices. Software implementation may include, for example, one or more computer programs, firmware, or other executable code. Firmware implementation may include, for example, one or more programs or code that is stored in a non-volatile memory, such as a read-only memory (ROM), a flash memory, or an erasable programmable read-only memory (EPROM).

If implemented in software, the operations may be stored as one or more instructions (or code) on a non-transitory computer-readable storage medium or a non-transitory processor-readable storage medium. A non-transitory computer-readable storage medium may include, for example, a hard disk drive, a solid state drive, a flash memory, a memory card, a CD-ROM, a DVD, etc.

The operations of a method or algorithm disclosed herein may be embodied in a processor-executable software module or as processor-executable instructions, both of which may reside on a non-transitory computer-readable or processor-readable storage medium. A processor-executable software module may include, for example, a computer program, firmware, or other executable code that is executed by a processor. Processor-executable instructions may include, for example, one or more instructions that are executed by a processor.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the specific embodiments described herein but is to be accorded the widest scope consistent with the claims.

1. A modular bath bomb vessel comprising:
a vessel base including
a bath salt chamber,
a plurality of inlet holes,
a plurality of outlet jets spaced equidistantly around the base, and
a plurality of manually controllable open/close valves, each of said valves configured to permit a fluid into or block the fluid from a corresponding one of the plurality of outlet jets;
a lid configured to releasably attach to the base, the lid including one or more outlet holes; and
a modular top portion including a base configured to releasably attach to the lid, the base of the modular top portion including one or more outlet holes corresponding in position to the one or more outlet holes in the lid.

2. The modular bath bomb vessel of claim 1, wherein each of the plurality of outlet jets is rotatably mounted to the base.

3. The modular bath bomb vessel of claim 1, wherein the bath salt chamber comprises a plurality of subchambers and walls separating the subchambers.

4. The modular bath bomb vessel of claim 3, wherein each subchamber in connected to a different one of said plurality of outlet jets.

5. The modular bath bomb vessel of claim 1, wherein the modular top portion includes a transparent enclosure connected to the base of the modular top portion.

6. The modular bath bomb vessel of claim 1, wherein the base of the modular top portion includes
one or more speakers,
one or more control buttons, and
electronic components to provide audio signals to the one or more speakers and receive input signals from the one or more control buttons.

7. The modular bath bomb vessel of claim 6, further comprising:
an interactive modular portion configured to attach to the modular top portion and including a plurality of user interface buttons.

8. The modular batch bomb vessel of claim 1, further comprising a rotatable element including an image rotatably mounted on the base of the modular top portion.
